(19) United States
(12) Patent Application Publication
(10) Pub. No.: US 2017/0098257 A1
(43) Pub. Date: Apr. 6, 2017

(54) System and Method for Optimizing Retail Fuel Stores

(71) Applicant: Skyline Products, Inc., Colorado Springs, CO (US)

(72) Inventor: John Windsor Keller, Manitou Springs, CO (US)

(73) Assignee: Skyline Products, Inc., Colorado Springs, CO (US)

(21) Appl. No.: 14/272,284

(22) Filed: May 7, 2014

(51) Int. Cl. G06Q 30/02; G06Q 10/06; G06F 17/30

(52) U.S. Cl. CPC G06Q 30/0283; G06F 17/30312; G06Q 10/067; G06Q 30/0226

(57) ABSTRACT

Multiple retail fuel stores are optimized using system having a computer in communication with a database. Remote computing devices are connected to the first computer by a communication system. Electronic signs receive an instruction over the communication system. The system creates a correlation matrix having fuel prices for the retail fuel stores, a reward discount, and competitor fuel prices, a profit for the fuel prices for each of the retail fuel stores, and a volume. It also creates an economic model that receives a number of correlation coefficients from the correlation matrix at the first computer. A multi-store optimization process configures the economic model to determine optimal fuel prices for retail fuel stores based on a total multi-store profit.

### RELATED APPLICATIONS

The present invention claims priority on provisional patent application, Ser. No. 61/831,722, filed on Jun. 6, 2013, entitled “Additional Capabilities For A Price Optimization System For A Chain Of Retail Fuel Stores” and both are hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

There are numerous price optimization systems for a general merchandise store or grocery stores, but the retail motor fuel store has different requirements. The price of the main product these stores sell, gasoline, is announced to the world and competitors on large, visible signs. This is different than any other retail outlet and requires different price optimization systems. There have been attempts to create a price optimization routine for these stores but they have not been highly successful for a variety of reasons, including the failure to understand that these stores often have very seasonal traffic patterns and that these systems pick a price for the fuel without giving the user an explanation of what his choices are.

In the retail motor fuel price management industry, when retailers price their fuel products like gasoline and diesel there are similarities to non-fuel retail pricing practices, but there are significant differences as well. On one hand, motor fuel products, like all retail products, must be priced according to perceived relative value compared to the competition, so retailers pay close attention to the price charged by the competition. Pricing strategies are carefully monitored by measuring the ongoing sales volumes, and prices are changed when needed. But unlike other retailers, fuel retailers must deal with a constantly changing replacement cost of fuel, and a much more public display of their fuel products pricing. In the 1960's, the replacement cost of fuel was relatively static, so fuel retailers could be successful simply by setting their retail fuel prices once for the month, and updating their retail fuel prices every 30 days. But now replacement costs are so volatile, retailers are likely paying a higher or lower price for each load of fuel they receive, and that can be as frequently as multiple times in one day. In addition, not only must the fuel prices be prominently displayed on the outdoor sign for all consumers to see and compare to the competition, but more and more consumers are browsing websites from their mobile devices to compare fuel prices so they can plan which fuel retailer to buy from based on their travel plans, especially when travelling out of town.

Additionally, the retail motor fuel price management industry has become more complex because of the introduction of rewards programs. Consumer buying behavior is now heavily influenced by the points consumers accrue by purchasing in-store merchandise from convenience stores and grocery stores. For example, if a consumer purchases $100 in groceries, that person may earn enough rewards points worth a $0.10 per gallon discount for gasoline at a participating fuel retailer. When a retailer introduces a fuel discount rewards program, it immediately impacts their fuel pricing strategy. Fuel rewards programs must constantly be reviewed to see how much impact they have on consumer behavior and fuel volume sales. When a competitor introduces a fuel rewards program, the retailer must be careful to identify what competitive price is being reported in their competitor surveys: the full price or the rewards price.

Another important characteristic of the retail motor fuel industry is that the overall retail motor fuels market is experiencing shrinking volumes. As retailers are competing for an ever-shrinking motor fuels volume market, competition is increasingly intense, and the right fuels pricing decisions are increasingly critical because there is less room for error by selecting the wrong price for any individual commodity. Motor fuel retailers need a solution that allows them to better understand the competitive nature of all the products they sell, in all the markets in which they compete, on every street corner where they have a store, the fuel pricing relationship with their competitors, and the overall price elasticity of motor fuels with their customers both on a per-product basis and as a product family.

One more aspect of the retail motor fuel industry that adds to the complexity of fuel pricing is regulatory compliance. The first common fuel pricing compliance issue is related to cost. Motor fuel retailers are often legally not allowed to sell fuel below cost. Consequently, the economic model optimization must be aware of cost on an individual product basis as well as across a family of products. The second issue motor fuel retailers face is related to price change frequency. Motor fuel retailers are often legally not allowed to make changes to their fuel prices more frequently than once every 24 hours, that means their fuel pricing system must allow for price changes to be made no more frequently than once in a 24 hour period when fuel retailers are operating in this context.

Other optimization patents already exist for the retail space, allowing optimized prices to be calculated for a product based on predicted sales volumes. However, none of these optimization models will work in the retail motor fuel price management industry because the retail motor fuel price management industry is so volatile in both cost and competitor price. Retail motor fuel cost calculations are not based on LIFO or FIFO accounting practices, but are instead based on the current published RACK cost of fuel by fuel supplier and terminal. This means retail motor fuel retailers always base their current margins on replacement cost, which is, current RACK cost, plus freight, tax and any other cost. In other words, current retail fuel margins are based not on the actual cost they paid for the fuel inventory they paid in the tanks, but on how much it would cost to fill an empty fuel tank at any moment in time. In some cases, fuel pricing is based on anticipated future replacement costs based on trends in the NYMEX commodities futures market, specifically the cost trend of a barrel of crude oil, whether it be Brent or WTI crude. Only by using the replacement margin that retail motor fuel retailers are able to survive in an industry where costs are so volatile. Existing optimization patents are also unusable in the retail motor fuels industry because the competitor prices change so dramatically and so frequently. Further, consumers are able to easily compare prices between retailers and buy based on price more easily than in other markets because the price of motor fuel is so prominently displayed on the store signs. This means motor fuel retailers must react quickly to competitor price changes in the market. This is especially true when a competitor introduces a rewards program and immediately has an impact on sales for the existing store.

Thus there exists a need for a fuel store(s) optimization system that takes the unique nature of the retail fuel stores environment into account.

### BRIEF SUMMARY OF INVENTION

A method of optimizing one or more retail fuel stores that overcomes these and other problems uses a system having a first computer in communication with a database. Remote computing devices are connected to the first computer by a communication system. A number of electronic signs receive an instruction over the communication system. The system creates a correlation matrix having a number fuel prices for each of the retail fuel stores, a reward discount for each of the retail fuel stores, and a number of competitor fuel prices at the first computer, a profit for the fuel prices for each of the retail fuel stores, and a volume for each of the fuel prices for each of the retail fuel stores. It also creates an economic model that receives a number of correlation coefficients from the correlation matrix at the first computer. A multi-store optimization process configures the economic model to determine optimal fuel prices for each of the retail fuel stores based on a total multi-store profit. The optimal fuel prices for each of the retail fuel stores based on a total multi-store profit is transmitted to the electronic signs and displayed. Thus the total multi-store profit is maximized.

### BRIEF DESCRIPTION OF THE SEVERAL VIEWS OF THE DRAWINGS

FIG. 1 is a block diagram of a system for optimizing retail fuel stores in accordance with one embodiment of the invention;

FIG. 2 is a block diagram of the processes for optimizing retail fuel stores in accordance with one embodiment of the invention;

FIG. 3 is a schematic layout of a multi-store optimization process in accordance with one embodiment of the invention;

FIG. 4 is a schematic layout of a store optimization process in accordance with one embodiment of the invention;

FIG. 5 is a flow chart of a replacement costs profit process in accordance with one embodiment of the invention;

FIG. 6 is a flow chart of a competitor price rewards process in accordance with one embodiment of the invention;

FIG. 7 is a pair of charts showing expected profit versus price and expected volume versus price in accordance with one embodiment of the invention;

FIG. 8 is a flow chart of a method for optimizing retail fuel stores in accordance with one embodiment of the invention; and

FIG. 9 is a flow chart of a method for optimizing retail fuel stores in accordance with one embodiment of the invention.

### DETAILED DESCRIPTION OF THE INVENTION

The invention is directed to a system and method of optimizing one or more retail fuel stores that uses a system having a first computer in communication with a database. Remote computing devices are connected to the first computer by a communication system. A number of electronic signs receive an instruction over the communication system. The system creates a correlation matrix having a number fuel prices for each of the retail fuel stores, a reward discount for each of the retail fuel stores, and a number of competitor fuel prices at the first computer, a profit for the fuel prices for each of the retail fuel stores, and a volume for each of the fuel prices for each of the retail fuel stores. It also creates an economic model that receives a number of correlation coefficients from the correlation matrix at the first computer. A multi-store optimization process configures the economic model to determine optimal fuel prices for each of the retail fuel stores based on a total multi-store profit. The optimal fuel prices for each of the retail fuel stores based on a total multi-store profit is transmitted to the electronic signs and displayed. Thus the total multi-store profit is maximized.

This application hereby incorporates by reference U.S. patent application Ser. No. 12/250,273, entitled “System and Method for Controlling Outdoor Signs”, US patent publication number 20110246313.

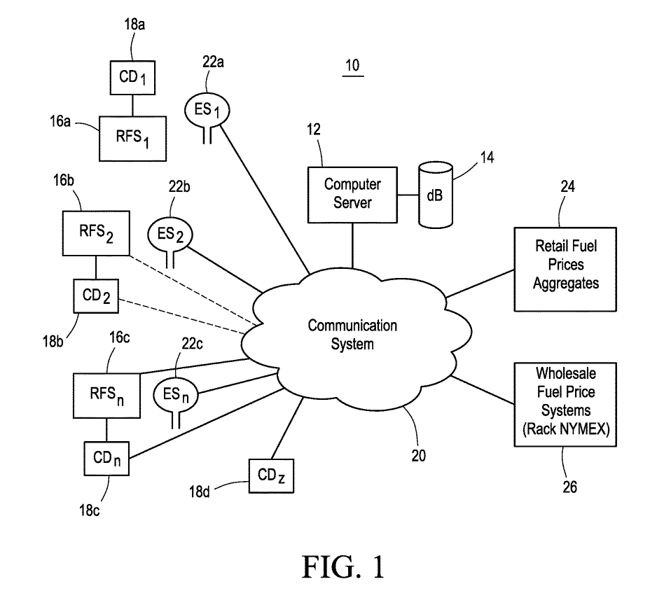

FIG. 1 is a block diagram of a system 10 for optimizing retail fuel stores in accordance with one embodiment of the invention. The system 10 includes a first computer system 12 in communication with a database 14. A plurality of retail fuel stores (RFS) 16a, 16b, 16c, have one of more computing devices 18a, 18b, 18c, 18d connected to a communication system 20. Note the communication system 20 may be the Internet, wireless telephone network, wifi, local area networks, telephone network, etc. or any combination of the above and some parts may be owned by different companies. For instance, a computing device 18a may communicate with an electronic sign (EF) 22a using a peer to peer spread spectrum local network or a may using a wired Ethernet system and the computing device 18a may connect to the computer/server 12 using a combination of the cellular network and the internet. The computing devices 18a, 18b, 18c, 18d may be client computers, point of sale devices, smart phones, and the like. Some of the computing devices 18d may not be associated with a specific retail fuel store location. A number of retail fuel price aggregators 24 are connected to the first computer 12 by the communication system 20. These retail fuel price aggregators are services such GasBuddy, Cheapgas, and others. However, fuel prices may be also be gathered locally by the retail fuel store 16a, 16b, 16c, employee and transmitted using a computing device 18a, 18b, 18c to the computer server 12 to be stored in the database 14. The computer/server 12 is also connected to wholesale fuel price systems 26 which provide the RACK price (current wholesale price for fuel) or futures prices from futures markets such as NYMEX (NY Mercantile Exchange).

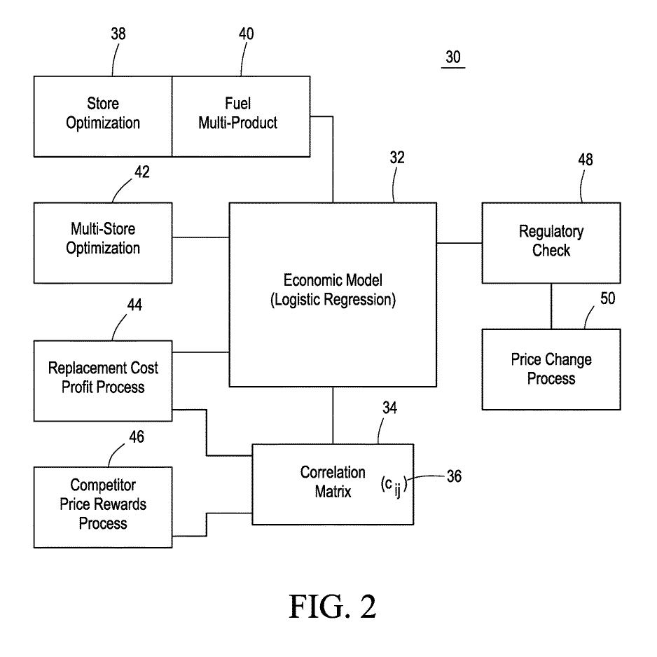

FIG. 2 is a block diagram of the processes 30 for optimizing retail fuel stores in accordance with one embodiment of the invention. An economic model 32 creates a model of a store's fuel prices versus profit or volume. The economic model 32 can be used to create a model of the effects of competitor prices, merchandise prices, rewards programs, hourly trends, daily trends, seasonal trends, multi-store models, etc. The economic model 32 in one embodiment is a logistic regression process. The optimization system can be quantified by understanding the price elasticity by store, by product, by grade and by day. This quantification or optimization interprets historical elasticity for each store, by product, by grade, by same day of week, with option for user variable input to address seasonality considerations and market disruptions. The system recommends price changes to optimize the balance of volume and/or margin based on statistically relevant elasticity and within user defined constraints. By utilizing the optimization slider, this allows for varying percentages of volume vs. margin goals. By leveraging the “Proposed Prices” page or user defined email alerts, users can review, modify and accept optimized price recommendations as well as a combination of strategy prices with conditions can be automatically executed. So a combination of “what if” scenarios or automatically executed price changes can be realized with the system. The economic model allows for the user's ability to forecast the volume and margin impact of a price change and display for pricing team user to evaluate. In essence, the economic model can be forward looking, i.e. what would be the impact of a scheduled price change to take effect tomorrow as opposed to an immediate price change. With competition and retail fuel pricing volatility so prevalent, the optimization system can automatically determine the top competitors (e.g., five) which will make a difference in the user's pricing decisions. This accommodates market volatility in a learning model.

Statistical Methodology: A range of prices are offered to provide strategic insight into the pricing options with a range of +/−$0.10. The range of pricing options in $0.01 increments plot the volume and profit from each point on the curve. Furthermore, the model suggests the profit maximization point within the curve. The models are based on logistic multiple regressions and secondarily a correlation matrix 34 based on historical identified competitor pricing. The variables in the economic model consist of the change in competitive price movement, competitive index, volume gallon sales by commodity, and wholesale cost changes, date, date range, day of week, commodity pricing, among others.

Logistic models are used for prediction of the probability of occurrence of an event by fitting data to a logit function logistic curve; it is a generalized linear model used for binomial regression. Like many forms of regression analysis, it makes use of several predictor variables that may be either numerical or categorical. Logistic regression is used extensively in the medical and social sciences as well as marketing applications such as prediction of a customer's propensity to purchase a product or cease a subscription.

Correlations are useful because they can indicate a predictive relationship that can be exploited in practice. Correlations can also suggest possible causal or mechanistic relationships; however, statistical dependence is not sufficient to demonstrate the presence of such a relationship. A correlation matrix 34 is connected to the economic model 32 and contains a plurality of correlation coefficients 36.

Formally, dependence refers to any situation in which random variables do not satisfy a mathematical condition of probabilistic independence. In general statistical usage, correlation or co-relation can refer to any departure of two or more random variables from independence, but most commonly refers to a more specialized type of relationship between mean values.

There is a caution while using a correlation matrix 34 for competitive pricing. First, it is only on the number of competitors specified. Secondly, correlation does not imply causation; therefore the amount of fuel volume and/or price change due to a single competitor may not necessarily lead to the amount of fuel volume and/or margin.

Validity and reliability of the model analysis must also consider correcting for non-normal data distributions, skewness, and heteroscedasticy and homoscedasticity. The economic model is formulated within a non-sterile environment with real-world dirty data provided by actual customers. The economic model provides solutions where there is non-normal data distributions.

The economic model 32 is configurable by a store optimization process 38. The store optimization process 38 includes a number of options such a fuel price versus profit or volume or for multiple fuel prices 40. A multi-store optimization process 42 configures the economic model 32 to determine a maximum profit across multiple stores of the same company by defining the optimal fuel price(s). This is particularly important when a company has two or more retail fuel stores that are close to each other and seen by consumers as alternatives or competitors. A replacement costs and profit process 44 provides fuel prices and profit calculations to the economic model 32 and the correlation matrix 34. A competitor price rewards process 46 determines if a reported price is like to be a rewards price. This information is passed to the correlation matrix 34. The economic model has a number of outputs which usually includes a proposed price. This proposed price(s) are checked against regulatory requirements by the regulator check process 48. Two of the important checks are that the proposed price is not below cost, which is prohibited in many states and that the timing of the proposed price is allowed. For instance, some states only allow stores to change their fuel prices once a day. A price change process 50 may propagate the proposed prices to the electronic signs 22a, 22b, 22c, where the displayed price will be updated automatically, or it may send a chart of the possible choices on the proposed changes to a user who will select the updated price to be propagated to the electronic signs 22a, 22b, 22c. There the proposed change may be approved manually or the user may receive a chart of the possible choices and select the updated price to be propagated to the electronic signs 22a, 22b, 22c.

The price optimization system presents a method for scheduling price changes 50 into the future, as either a onetime price change event, or a set of recurring price change events. Scheduled price changes may apply to an individual store or a region of stores. Scheduled price changes ensure compliance with regulations related to price change frequency during times of market price adjustment when motor fuel retailers need to increase prices to recover from cost increases, but cannot increase prices more frequently than a specified number of hours (most typically 24 hours). Scheduled price changes enable price optimization at specific times in a day or week by allowing repeating price specials to be scheduled, to bring in additional customer traffic to the store, and to build customer loyalty.

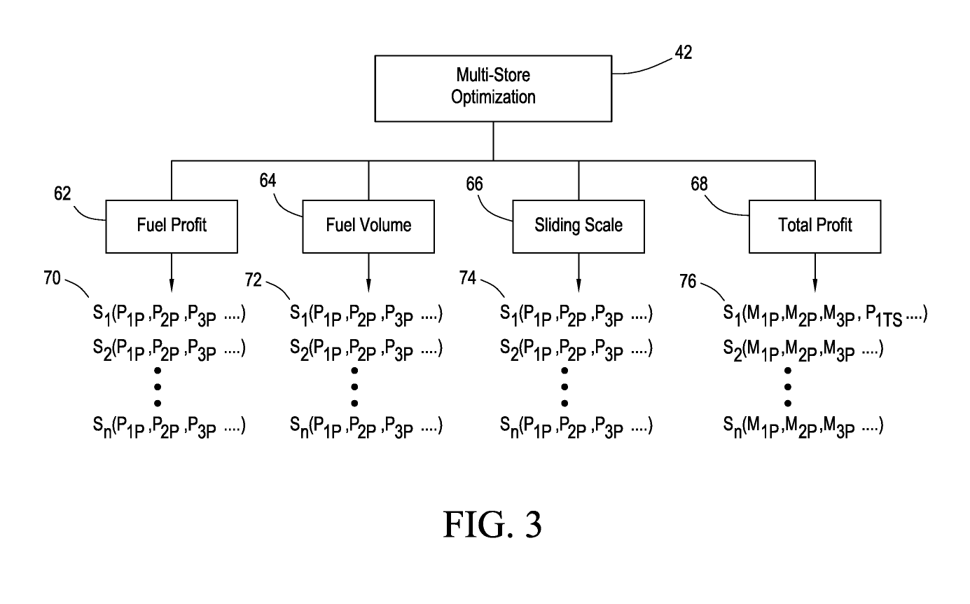

FIG. 3 is a schematic layout of a multi-store optimization process 42 in accordance with one embodiment of the invention. The process starts by the user selecting either to maximize fuel profit 62 for the stores; maximize fuel volume 64, or some combination of volume and profit—sliding scale 66; or total store profit 68. If fuel profit is maximized the economic model provides a tuple for the first store 70 that includes the optimized profit price for regular, mid-grade, premium, diesel, etc. A similar tuple is provided for each of the other stores. If fuel volume is maximized the economic model provides a tuple for the first store 72 that includes the optimized volume price for regular, mid-grade, premium, diesel, etc. A similar tuple is provided for each of the other stores. If the sliding scale is used, the user selects a balance between profit and volume considerations from only profit to only volume and the economic model provides a tuple for the first store 74 that includes the optimized profit/volume price for regular, mid-grade, premium, diesel, etc. A similar tuple is provided for each of the other stores. If total stores profit is maximized the economic model provides a tuple for the first store 76 that includes the optimized profit price for regular, mid-grade, premium, diesel, etc and optimal prices for merchandise (M₁ₚ, etc). A similar tuple is provided for each of the other stores.

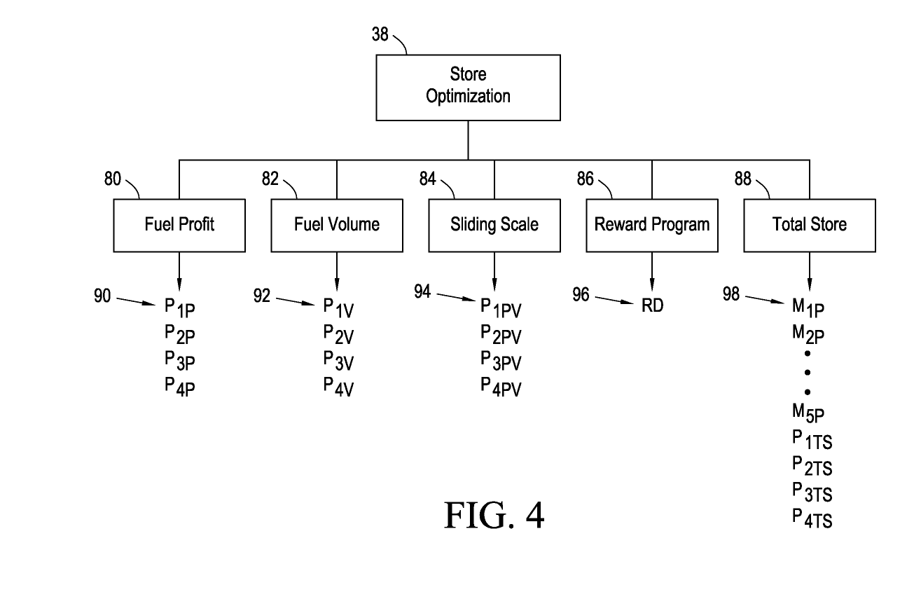

FIG. 4 is a schematic layout of a store optimization process 38 in accordance with one embodiment of the invention. The process starts by the user selecting either to maximize fuel profit 80 for the store; maximize fuel volume 82, or some combination of volume and profit—sliding scale 84; maximize the reward program price 86; or total store profit 88. If fuel profit is maximized the economic model provides a tuple for the store 90 that includes the optimized profit price for regular, mid-grade, premium, diesel, etc. If fuel volume is maximized the economic model provides a tuple for the store 92 that includes the optimized volume price for regular, mid-grade, premium, diesel, etc. If a fuel sliding scale is selected a fuel/volume optimization level is maximized and the economic model provides a tuple for the store 94 that includes the optimized fuel/volume price for regular, mid-grade, premium, diesel, etc. If the rewards program is selected a rewards discount is maximized and the economic model provides a rewards discount 96. If total store profit is selected a total store profit optimization level is maximized and the economic model provides a tuple for the store 98 that includes the optimized fuel/volume price for regular, mid-grade, premium, diesel, etc, and the price of various merchandise.

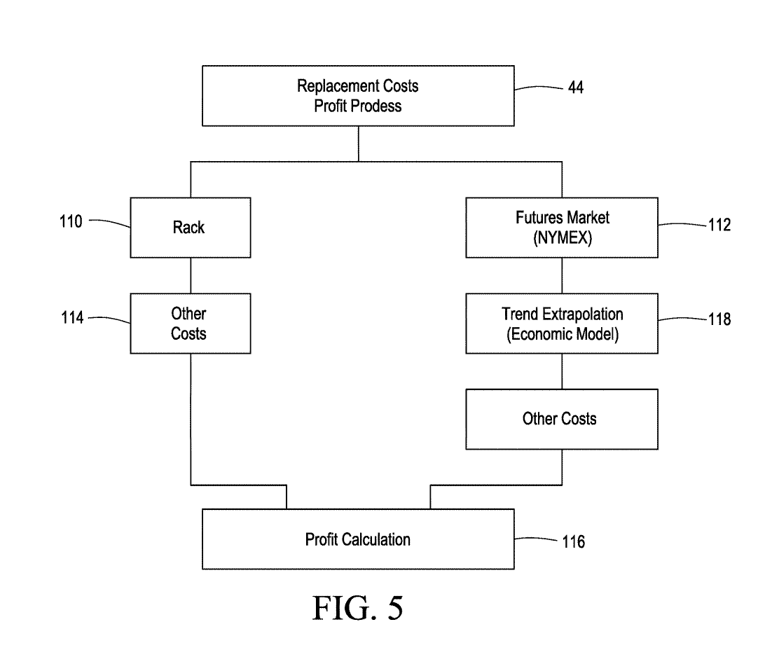

FIG. 5 is a flow chart of a replacement costs profit process 44 in accordance with one embodiment of the invention. First the user selects to base the cost on Rack price (current wholesale price) 110 or based on the futures market 112. If the rack price 110 is used then the costs of transportation, taxes and other costs 114 are added to the rack cost. This cost figure is then used in the profit calculation 116. If the futures 112 price is used, a trend extrapolation may be done 118. This may be performed by the economic model 32. Other costs are then added 120.

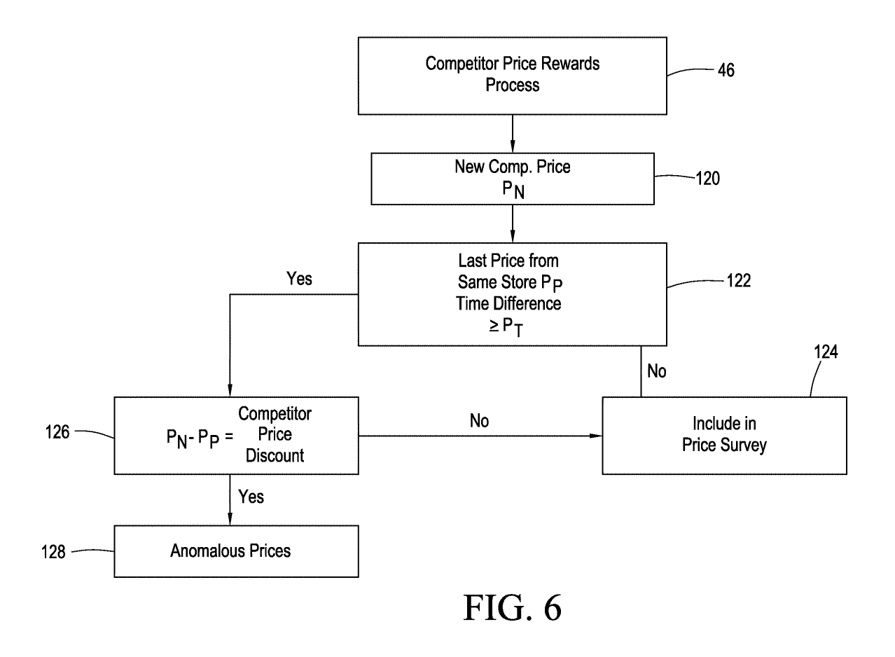

FIG. 6 is a flow chart of a competitor price rewards process 46 in accordance with one embodiment of the invention. When a new competitor price is received 120 the time since the last reported competitor price 122 is compared to a predetermined time. If the time is greater than the predetermined time, then the price is included in the price survey 124. If the time is less than the predetermined time, then it is determined if the difference in price is equal to the competitor fuel discount 126. If the price difference is equal to the competitor fuel discount, then the price is stored as an anomalous price 128 from the price survey, otherwise it is included. Note that anomalous prices are not used to determine the optimal fuel prices in processes 38 & 40, however they may be used to determine the effectiveness of competitor rewards programs or in setting the user's rewards discount.

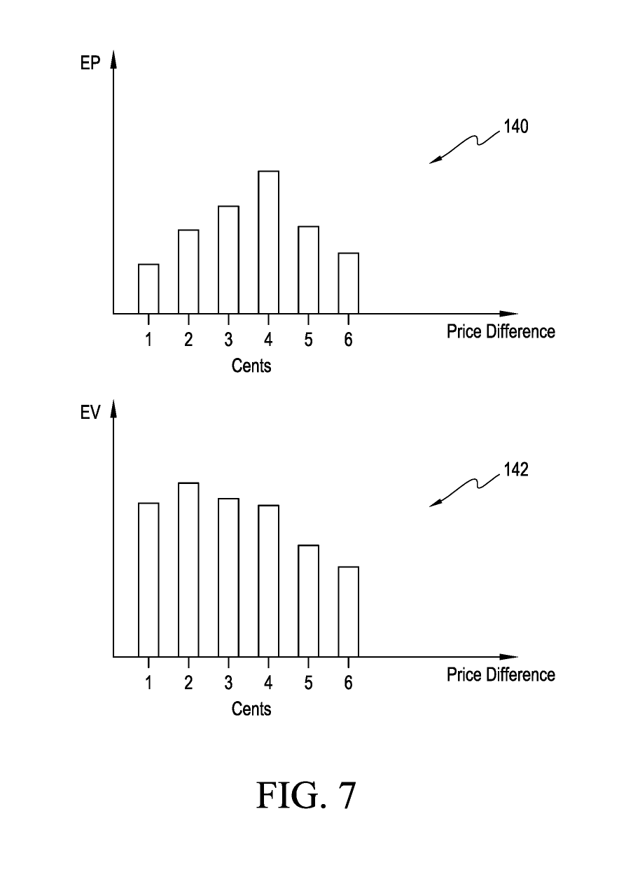

FIG. 7 is a pair of charts 140, 142 showing expected profit versus price and expected volume versus price in accordance with one embodiment of the invention. The charts show the price, usually in penny increments, against the expected profit (EP) or the expected volume (EV).

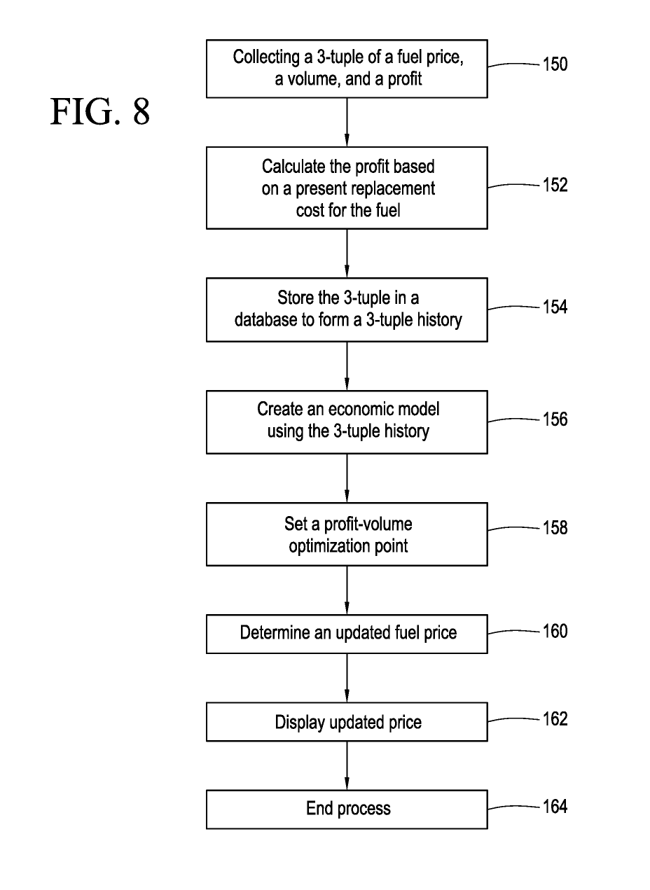

FIG. 8 is a flow chart of a method for optimizing retail fuel stores in accordance with one embodiment of the invention. The process starts, step 150, by collecting a 3-tuple of a fuel price, a volume, and a profit for at least one or more retail fuel stores on a periodic basis, wherein the profit is calculated based on a present replacement cost for the fuel at step 152. The 3-tuple is stored in the database to form a 3-tuple history at step 154. An economic model is created using the 3-tuple history at the first computer at step 156. A profit-volume optimization point is set at step 158. An updated price of the fuel is determined based on the profit-volume optimization point at step 160. At step 162 the updated price is displayed on the electronic sign(s), which ends the process at step 164.

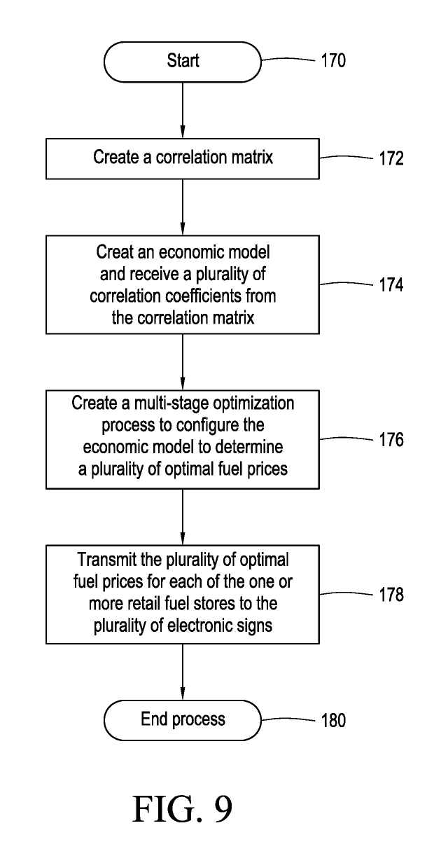

FIG. 9 is a flow chart of a method for optimizing retail fuel stores in accordance with one embodiment of the invention. The process starts, step 170, by creating a correlation matrix including a plurality fuel prices for each of the one or more retail fuel stores, a reward discount for each of the one or more retail fuel stores, and a plurality of competitor fuel prices for a plurality of competitors at the first computer, a profit for each of the plurality fuel prices for each of the one or more retail fuel stores, a volume for each of the plurality fuel prices for each of the one or more retail fuel stores at step 172. Next an economic model is created and receives a plurality of correlation coefficients from the correlation matrix at the first computer at step 174. A multi-store optimization process is created that configures the economic model to determine a plurality of optimal fuel prices for each of the one or more retail fuel stores based on a total multi-store profit at step 176. At step 178, the plurality of optimal fuel prices for each of the one or more retail fuel stores based on a total multi-store profit is transmitted to the plurality of electronic signs and displayed, which ends the process at step 180

This system uses numerous computing devices and communication systems. All of these systems are physical and result in the use of energy, movement of electrons, and the changing states of transistors. A computer is an electronic circuit that is wired using software. Software is a set of wiring instructions that are converted into the native language of a computer by a complier (or interpreter). The native machine language changes voltages in the computer to configure switches, i.e., transistors, to wire the electronic circuit that is a computer. The output of the computer is electronic messages (changes in voltages), which eventually turn on and off various lights, store electronic voltages (charges or states of transistors) that are indicative of the information desired by the user. Everything described herein can be implemented in hardware without a computer, because a computer is hardware. The methods described herein are a new and useful processes, the system to implement these processes are new and useful machines. The invention, like all inventions is how these elements are combined together. Every invention in the history of the world is a unique combination of existing elements, since conservation of matter and energy mean that no one can create something out of nothing. Looking at the elements in isolation is both not allowed under the law and logically absurd.

Thus there has been described a fuel store(s) optimization system that takes the unique nature of the retail fuel stores environment into account.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for optimizing one or more retail fuel stores, comprising:
a first computer configured to carry out a plurality of processes and connected to one or more fuel price gathering systems;
a database in communication with the first computer, containing data on fuel prices, fuel volumes, and one or more retail fuel stores;
a communication system connecting the first computer to the one or more fuel price gathering systems;
a plurality of computing devices connected to the communication system;
an automated sign connected to the communication system;
wherein the one of the plurality processes includes a process for determining if a competitor price is a fuel discount price.

2. The system of claim 1, further including a correlation matrix in communication with the database having a plurality of correlation coefficients between a first fuel price, a second fuel price, a volume of fuel sold, a profit margin, and a cost of fuel.

3. The system of claim 1, wherein one of the plurality of processes is a fuel profit process that includes a RACK price of a fuel.

4. The system of claim 1, wherein one of the plurality of processes is a strong price process.

5. The system of claim 1, wherein one of the plurality of processes is a price change process.

6. The system of claim 2, wherein one of the plurality of processes is a multiproduct optimization that is in communication with the correlation matrix, wherein the first fuel price is optimized to the second fuel price to produce a maximum total profit.

7. The system of claim 2, wherein one of the plurality of processes is a multi-store optimization that is in communication with the correlation matrix, wherein a fuel price for each of the one or retail fuel store is set to provide a maximum total multi-store profit.

8. The system of claim 2, wherein one of the plurality of processes is a total store profit optimization that is in communication with the correlation matrix, wherein a fuel price and a plurality of merchandise prices are set to provide a maximum total store profit.

9. The system of claim 1, wherein one of the plurality processes is an economic model process that includes a logistic regression process.

10. The system of claim 9, further including a correlation matrix process that provides a plurality of inputs to the logistic regression process.

11. A method of optimizing one or more retail fuel stores using a system having a first computer in communication with a database, one or more remote computing device connected to the first computer by a communication system, and an electronic sign receiving an instruction over the communication system, the method comprising the steps of:
collecting a 3-tuple of a fuel price, a volume, and a profit for at least one or more retail fuel stores on a periodic basis, wherein the profit is calculated based on a present replacement cost for the fuel;
storing the 3-tuple in the database to form a 3-tuple history;
creating an economic model using the 3-tuple history at the first computer;
setting a profit-volume optimization point;
determining an updated price of the fuel based on the profit-volume optimization point; and
displaying the updated price on the electronic sign.

12. The method of claim 11, wherein the step of setting a profit-volume optimization point includes the step of creating a chart of the updated price against a projected profit.

13. The method of claim 12, further including the step of creating a chart of the updated price against a projected volume.

14. The method of claim 11, wherein the step of collecting the 3-tuple includes collecting a 4-tuple containing a fuel rewards discount and creating a correlation matrix with a correlation coefficient between the fuel reward discount and the profit.

15. The method of claim 14, further including the step of using the economic model and the correlation coefficient between the fuel reward discount and the profit to determine an optimum fuel rewards discount.

16. The method of claim 11, further including a competitor price process which provides a 2-tuple to the economic model and includes the steps of,
the competitor price process receives a reported competitor fuel price,
comparing a last reported competitor fuel price to the competitor fuel price;
when the difference between the last reported competitor fuel price and the competitor fuel price is equal to a competitor fuel discount, storing the 2-tuple of the reported competitor fuel price in an anomalous price file.

17. The method of claim 16, further including the steps of when the difference between the last reported competitor fuel price and the competitor fuel price does not equal the competitor fuel discount, storing the 2-tuple of the reported competitor fuel price and the store in a price survey.

18. The method of claim 16, wherein the step of comparing the last reported competitor fuel price to the competitor fuel price, include a time between the last reported competitor fuel price and the competitor fuel price,
when the time between the last reported competitor fuel price and the competitor fuel price is less than a predetermined period of time storing the 2-tuple of the reported competitor fuel price and store in the anomalous price file of the database.

19. The method of claim 11, wherein the step of displaying the updated price on the electronic sign, includes the steps of:
determining a last time a fuel price was updated;
when the last time the fuel price was updated was less than a predetermined period of time, discarding the updated price.

20. The method of claim 11, wherein the step of determining the updated price includes the step of determining if the updated price is less than an actual cost of fuel, when the updated price is less than the actual cost of fuel discarding the updated price.

21. A method of optimizing one or more retail fuel stores using a system having a first computer in communication with a database, one or more remote computing device connected to the first computer by a communication system, and a plurality of electronic signs receiving an instruction over the communication system, the method comprising the steps of:
creating a correlation matrix including a plurality fuel prices for each of the one or more retail fuel stores, a reward discount for each of the one or more retail fuel stores, and a plurality of competitor fuel prices for a plurality of competitors at the first computer, a profit for each of the plurality fuel prices for each of the one or more retail fuel stores, a volume for each of the plurality fuel prices for each of the one or more retail fuel stores;
creating an economic model receiving a plurality of correlation coefficients from the correlation matrix at the first computer;
creating a multi-store optimization process, configuring the economic model to determine a plurality of optimal fuel prices for each of the one or more retail fuel stores based on a total multi-store profit,
transmitting the plurality of optimal fuel prices for each of the one or more retail fuel stores based on a total multi-store profit to the plurality of electronic signs; and
displaying the plurality of optimal fuel prices for each of the one or more retail fuel stores, whereby the total multi-store profit is maximized.

22. The method of claim 21, further including the steps of:
creating a store optimization process, configuring the economic model to determine a plurality of optimal volume fuel prices for each of the one or more retail fuel stores based on a total multi-store volume,
transmitting the plurality of optimal volume fuel prices for each of the one or more retail fuel stores based on a total multi-store volume to the plurality of electronic signs; and
displaying the plurality of optimal volume fuel prices for each of the one or more retail fuel stores, whereby the total multi-store volume is maximized.

23. The method of claim 21, further including the steps of:
incorporating a rewards fuel price in the correlation matrix;
configuring the economic model to determine an optimal rewards fuel price for each of the one or more retail fuel stores based on a reward fuel price coefficient;
determining an optimal rewards fuel price for each of the one or more retail fuel stores.

24. The method of claim 21, further including the step of:
configuring the economic model to determine an optimal store fuel prices for one of the one or more retail fuel stores;

25. The method of claim 21, further including the steps of:
incorporating a plurality of merchandise prices for one of the one or more retail fuel stores, a store profits for one of the one or more retail fuel stores in the correlation matrix;
configuring the economic model to determine an optimal merchandise prices and fuel prices for one of the one or more retail fuel stores using a store profits coefficient.

26. The method of claim 22, further including the steps of:
selecting a weighting factor between a store fuel profit and a store fuel volume;
configuring the economic model to an optimum fuel price for one of the one of the one or more retail fuel stores based on the weighting factor.

27. The method of claim 27, further including the step of:
displaying a graph of proposed fuel price and determined fuel profit and a store fuel volume.
